(19) United States
(12) Patent Application Publication
(10) Pub. No.: US 2003/0022690 A1
(43) Pub. Date: Jan. 30, 2003

(54) Concealed wireless telephone

(75) Inventors: Cathy S. Beyda, Cupertino, CA (US); William J. Beyda, Cupertino, CA (US)

Correspondence Address: SIEMENS CORPORATION, Intellectual Property Department, 186 Wood Avenue South, Iselin, NJ, 08830, US

(73) Assignee: Siemens Information and Communication Networks, Inc.

(21) Appl. No.: 09/917,373

(22) Filed: Jul. 27, 2001

(51) Int. Cl. H04M 1/00

(52) U.S. Cl. 455/556; 455/66

(57) ABSTRACT

A concealed telephone includes a telephone body that is hidden from view. Audio signals produced by the telephone are provided to an earpiece that is hidden in a pair of glasses, sunglasses, or jewelry. A microphone is incorporated into a tie tack, jewelry piece, or other location that is inconspicuous, such as in a pen. Signals between the earpiece and microphone are preferably transmitted wirelessly to the telephone by a Bluetooth™ or other short-range analog or digital wireless communication device. Alternatively, signals could be transmitted from the telephone to the earpiece and microphone via hidden wires.

### FIELD OF THE INVENTION

The present invention relates to communication systems in general and to wireless/cellular telephones in particular.

### BACKGROUND OF THE INVENTION

As most cellular telephone users know, there are many instances where receiving a call or even acknowledging that a user has a wireless or cellular telephone can be awkward. For example, in a meeting, it may seem disrespectful to break in order to answer a call or to allow other meeting participants to know that the user has a cellular telephone. Similarly, in environments like movies, restaurants, or theaters, the use of cellular phones is often prohibited.

Given these environments, there is a need for a mechanism that can allow users to stay in communication with others, while concealing the fact that they have a wireless or cellular telephone. While security devices exist whereby a user may have an earphone and a hidden microphone, these devices are generally connected to a private radio and not to a general purpose cellular or wireless telephone that can be called by any party.

### SUMMARY OF THE INVENTION

A concealed telephone system includes a cellular or wireless telephone that can make and accept telephone calls. An earpiece provides audio signals from the telephone to an ear of the user and a microphone receives voice signals from the user and provides them to the telephone. Each of the earpiece and microphone are hidden or camouflaged on the user.

According to one embodiment of the invention, the earpiece is incorporated into a pair of glasses/sunglasses or in jewelry such as an earring. A microphone may be incorporated into a tie tack, pen, or article of jewelry in a manner that is camouflaged.

In one embodiment of the invention, the earpiece and microphone are connected to the telephone via a short-range wireless communication link. Alternatively, the earpiece and microphone may be connected to the telephone by a hidden wire.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a concealed wireless or cellular telephone in accordance with the first embodiment of the present invention; and

FIG. 2 illustrates a concealed wireless or cellular telephone in accordance with another embodiment of the present invention.

### DETAILED DESCRIPTION OF THE PREFERRED EMBODIMENT

As indicated above, the present invention is a concealed telephone that a user can wear without attracting undue attention. For purposes of the present application, wireless telephones are interchangeable with cellular telephones and therefore it will be appreciated that although the following description uses the term cellular telephone, the invention is equally applicable to wireless telephones.

The concealed telephone system 10 includes a cellular telephone 12 that is of the size that can be conveniently carried in a purse, briefcase, article of clothing, or some other location where it is not readily detected. Audio signals from the telephone are transmitted to an earpiece 14 that is worn by the user. In one embodiment of the invention, the earpiece 14 is located on a pair of eyeglasses or sunglasses 16 worn by the user.

In order to capture the user's voice, the concealed telephone system 10 includes a microphone 22 that is placed in a nonconspicuous location. The microphone 22, for instance, may be incorporated in a tie tack, pen, watch, or other nonconspicuous article that is placed sufficiently close to the user's mouth to pick up the voice signals.

To communicate with the earpiece 14 and microphone 22, the cellular telephone 12 preferably includes a short-range analog or digital wireless transceiver such as a Bluetooth™ transceiver, the details of which are as specified at www.bluetooth.com. The Bluetooth™ transceiver 20 communicates with a Bluetooth™ transceiver 18 that is included as part of the earphone 14 and a Bluetooth™ transceiver 24 that is part of the microphone 22.

In addition, the telephone system 10 may include a user-activated switch 26 which, in the example shown, is located on the earpiece 14 or on the microphone 22 or elsewhere that performs a function when activated by the user. For example, the switch 26 may be used to answer a call when received.

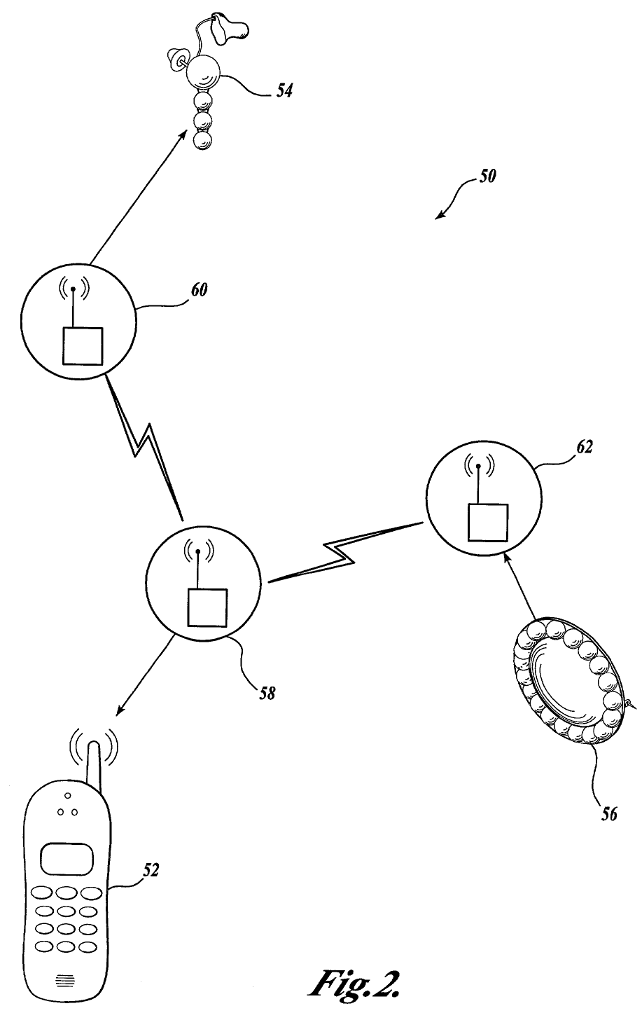

FIG. 2 illustrates an embodiment of the invention that may be more appropriate for women. The concealed telephone system 50 includes a cellular telephone 52, an earpiece 54, and a microphone 56. In this embodiment of the invention, the earpiece 54 is incorporated into an earring or some other concealed location that is placed near the user's ear. Audio signals from the telephone are transmitted to the earpiece 54 for reception by the user. The microphone 56 is provided to receive voice signals of the user. In this embodiment of the invention, the microphone 56 is included in a brooch or other article of jewelry or pen, button, etc., which can be worn inconspicuously by the user. As with the embodiment shown in FIG. 2, the cellular phone 52 includes an integrated wireless transceiver 54 that transmits and receives signals to corresponding wireless transceivers 60, 62 found in the earpiece and microphone, respectively.

Although the presently preferred embodiment of the invention utilizes wireless transceivers to transmit signals between the telephone and the earpiece and between the telephone and the microphone, it would be appreciated that hidden wires could also be used.

With the present invention, it is less likely that a user would be discovered monitoring a telephone. The telephone 12, 52 may be programmed such that upon receipt of a signal, the earpiece 14, 54 creates a low volume or otherwise recognizable tone to alert the user that a call has been received. The tone is such that disturbance to others is minimized. Alternatively, the earpiece or microphone may vibrate or produce some other tactile signal to alert the user that a call has been received.

In addition, the telephone 12, 52 may be programmed to answer a call with a message to a calling party that indicates the calling party has received a call on his or her concealed telephone and that the called party will answer when appropriate or convenient.

To not interfere with the user's ability to hear when not utilizing the telephone, the telephone 12, 52 may be programmed to transmit signals received by the microphone 22, 56 in a similar manner to that of a hearing aid so that the user is not deprived of the use of one ear when the earpiece is in place. Furthermore, for hearing impaired users, the sounds picked up by the microphone may be amplified.

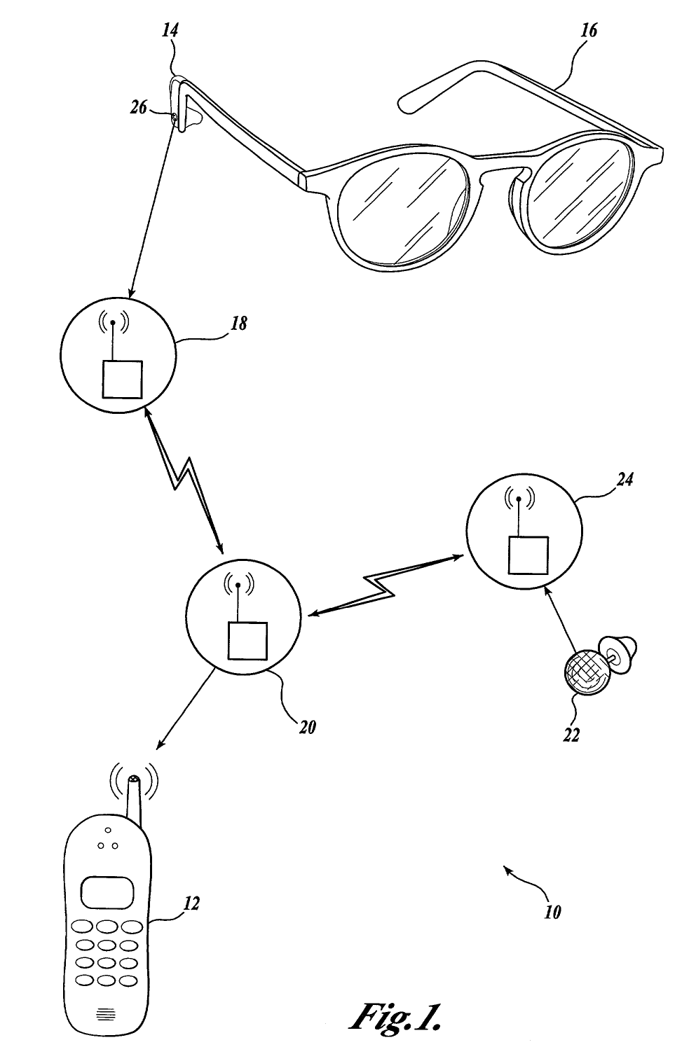

The telephone 12, 52 is preferably programmed to use voice recognition to dial a number or perform other telephone functions, such as recalling a number, working with the telephonic memory, altering telephone settings, etc. Therefore, by speaking commands into the microphone, the user can operate the telephone without having to remove it from its concealed location. Alternatively, the switch 26 of the type shown in FIG. 1 can be used to perform functions when selected by a user. For example, upon receipt of a call, a user may discreetly activate the switch 26 to answer the call in a manner that does not look conspicuous.

While the preferred embodiment of the invention has been illustrated and described, it will be appreciated that various changes can be made therein without departing from the scope of the invention. For example, as indicated above, the cellular telephone 12, 52 can be a wireless telephone for use in communicating with a remote base station. It is therefore intended that the scope of the invention be determined from the following claims and equivalents thereto.

The embodiments of the invention in which an exclusive property or privilege is claimed are defined as follows:

1. A concealed telephone system, comprising:
a telephone (12, 52) that can be hidden on the user and can make and receive telephone calls;
an earpiece (14, 54) that provides audio signals from the telephone to an ear of a user; and
a microphone (22, 56) that receives voice signals from the user and provides them to the telephone;
wherein each of the earpiece and microphone are camouflaged.

2. The concealed telephone of claim 1, wherein each of the telephone, earpiece, and microphone include short-range wireless transceivers (18, 20, 24) for transmitting signals therebetween.

3. The concealed telephone of claim 1, wherein the earpiece is concealed in a pair of glasses or sunglasses (16).

4. The concealed telephone of claim 1, wherein the earpiece is concealed in an article of jewelry (54).

5. The concealed telephone of claim 4, wherein the article of jewelry is an earring.

6. The concealed telephone of claim 1, wherein the microphone is concealed within a tie clip.

7. The concealed telephone of claim 1, wherein the microphone is concealed within a pen.

8. The concealed telephone of claim 1, wherein the microphone is concealed within an article of jewelry.

9. The concealed telephone of claim 1, wherein the telephone provides the ambient noise picked up by the microphone to the earpiece when the telephone is not in use.

10. The concealed telephone of claim 1, wherein the microphone (22, 56) and earpiece (14, 54) are connected to the telephone via a hidden wire.

11. The concealed telephone of claim 1, wherein the telephone is a cellular telephone.

12. The concealed telephone of claim 1, wherein the telephone is a wireless telephone.
